(19) United States
(12) Patent Application Publication
(10) Pub. No.: US 2016/0366417 A1
(43) Pub. Date: Dec. 15, 2016

(54) METHOD FOR SYNCHRONIZING ADAPTIVE BITRATE STREAMS ACROSS MULTIPLE ENCODERS WITH THE SOURCE ORIGINATING FROM THE SAME BASEBAND VIDEO

(71) Applicant: ARRIS Enterprises LLC, Suwanee, GA (US)

(72) Inventors: Pierre Seigneurbieux, Mountain View, CA (US); Domenico Guardini, Cupertino, CA (US); Basavaraj Hiremath, Sunnyvale, CA (US)

(21) Appl. No.: 15/178,954

(22) Filed: Jun. 10, 2016

Related U.S. Application Data
(60) Provisional application No. 62/173,474, filed on Jun. 10, 2015.

(51) Int. Cl. H04N 19/136; H04N 19/46

(52) U.S. Cl. CPC H04N 19/136; H04N 19/46

(57) ABSTRACT

A method is provided to synchronize Adaptive Bit Rate (ABR) video streams created from a single baseband video signal that is distributed through multiple different length coax transmission lines to different video encoders. The method inserts a marker in the baseband signal of the Serial Digital Interface (SDI). The baseband signal is then split with the inserted regular markers and distributed to encoders over different length coax transmission lines. Synchronizing the baseband video can then be performed using baseband receivers provided with the different encoders. A marker can be proprietary or can be based on timing standards for SDI such as vertical interval time code (VITC).

### CROSS REFERENCE TO RELATED APPLICATION

This application claims priority under 35 U.S.C. §119(e) from earlier filed U.S. Provisional Application Ser. No. 62/173,474 filed on Jun. 10, 2015 and incorporated herein by reference in its entirety.

### BACKGROUND

Technical Field

The present invention relates to distribute a single baseband video signal over multiple lines feeding different encoders that can be geographically distributed. In particular, the present invention relates to synchronization of the multiple bit rate (MBR) compressed video being output by the different encoders with the source originating from the same baseband signal.

Related Art

In some video signal distribution systems, the baseband signal is sent to multiple sites. However, with the signal being distributed to the multiple sites, synchronization of the encoded streams coming across different encoders will vary based on the actual distance between the signal source and the different encoders. As a result, when decoders sequentially tune to the MBR signals originating from different encoders in order to accommodate for maximum bitrate based on available bandwidth, the seamless switch between video streams will suffer from jumps forward or backward in time induced by the lack of precise synchronization in time between streams.

A serial digital interface (SDI) usually carries the single baseband signal that is distributed over different transmission lines, such as coaxial cable or fiber optic lines, to the different encoders. While encoders dealing with compressed video inputs use the clock present in the stream as a synchronization mechanism, there is no solution implemented today dealing with synchronizing streams being encoded from a baseband video. In other words, there is no existing solution making use of the inband signal components in a baseband video for the purpose of synchronizing the MBR streams in widely distributed video architectures.

It is desirable to provide a way to enable synchronization of a baseband signal distributed over long coaxial transmission lines to different encoders.

### SUMMARY

Embodiments of the present invention provide a method to make use of the inband signal components in a baseband video for the purpose of synchronizing the MBR streams in widely distributed video architectures.

Specifically, embodiments of the present invention provide a method to synchronize Multiple Bit Rate (MBR) video streams created from a single baseband video signal that is distributed through multiple different length coax transmission lines to different video encoders. The method inserts markers in the baseband signal of the Serial Digital Interface (SDI) that are used by the encoders to latch the same timing information such as Presentation Time Stamps (PTS) on identical frames across all compressed outputs generated by the different encoders. The baseband signal is then split with the inserted markers and distributed to encoders over different length coax transmission lines. Markers can be proprietary or can be based on available timing standards for SDI such as vertical interval time code (VITC).

### BRIEF DESCRIPTION OF THE DRAWINGS

Further details of the present invention are explained with the help of the attached drawings in which:

FIG. 1 illustrates a system that provides a single original source baseband signal that is distributed to multiple encoders, where the original baseband signal can be synchronized according to embodiments of the present invention;

FIG. 2 shows components of the IRD of FIG. 1 that enable processing of video signals and insertion of markers in accordance with embodiments of the present invention;

FIG. 3 is a flow chart illustrating a method of inserting markers in a baseband video in accordance with embodiments of the present invention; and

FIG. 4 is a flow chart showing a method of inserting VITC stamps as a marker in one embodiment of the system shown in FIG. 3.

### DETAILED DESCRIPTION

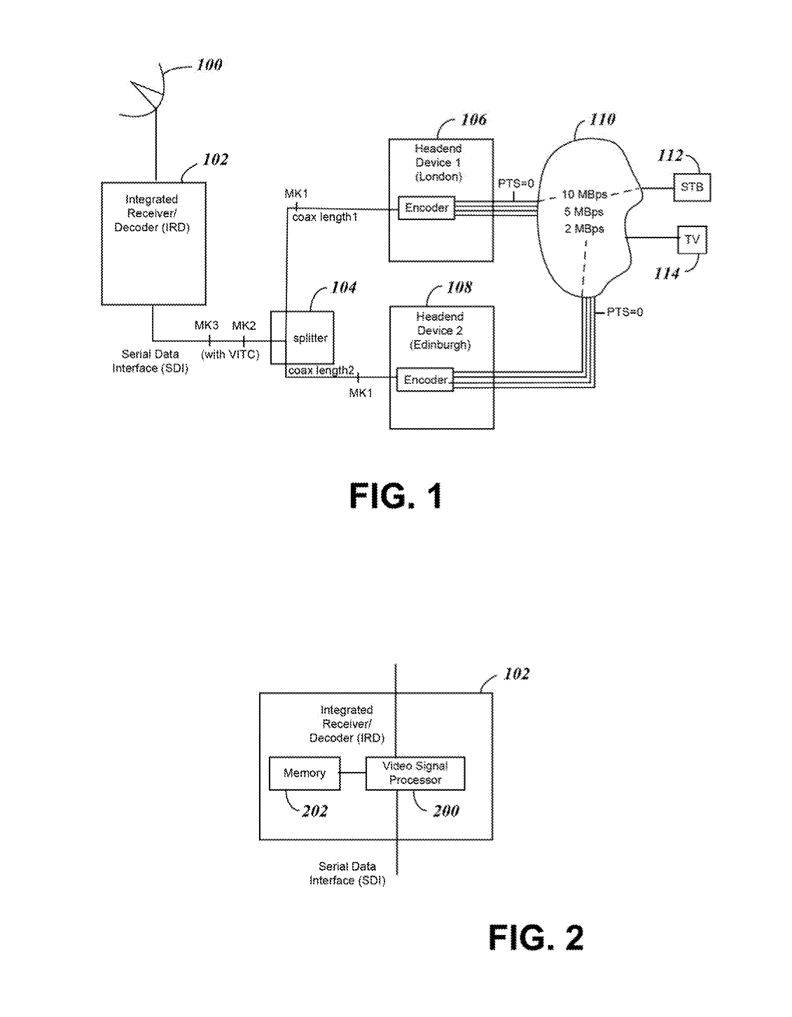

FIG. 1 shows a system that provides a single original source baseband signal that is distributed to multiple encoders, where the original baseband signal can be synchronized according to embodiments of the present invention. The initial baseband signal can be a channel signal received from a satellite 100, or other received video signal that is provided to an Integrated Receiver Decoder (IRD) 102. The IRD 102 includes components to format the original baseband video signal. The baseband video signal can be formatted as a Serial Data Interface (SDI) signal. That SDI can then be transmitted from the IRD 102 to multiple encoders in headend devices like 106 and 108.

In accordance with the present invention, the IRD 102 includes a processor that is programmed to provide markers in the IRD 102. The markers are inserted in the non-active video lines of the baseband video. The markers are illustrated as MK1, MK2 and MK3 in FIG. 1. The markers are inserted prior to the split of the single baseband signal at splitter 104 that distributes signals to different headend encoders 106 and 108. As can be seen after the split, the marker MK1 is separated and provided to the encoders 106 and 108 over different length coax lines. The different length coax lines mean that the markers like MK1 will arrive at the encoders of headend devices 106 and 108 at different times. But the markers will enable the encoders to synchronize the original baseband signal so that the same signal output from the encoder will be synchronized.

FIG. 2 shows components of the IRD of FIG. 1 that enable processing of video signals and insertion of markers in accordance with embodiments of the present invention. The IRD 102 includes a video signal processor 200 and connected memory 202 to enable video processing to perform the method according to embodiments of the present invention. The memory 202 stores code that enables the processor 200 to perform operations, including video signal processing to insert markers in the non-active portion of the baseband signal according to embodiments of the present invention.

The output of the encoders in headend devices 106 and 108 are distributed from the headend devices where they are contained to home gateways or directly to client devices like set top boxes 112 or TV 114. As shown, the Presentation Time Stamp (PTS) in the encoded signal can now be provided to allow signal synchronization. The signal strength of a single channel can be set at 10 Mega Bits Per Second (MBps) for higher quality signals, 5 MBps for good signals and 2 MBps for low quality signals.

Typically a signal from one headend encoder, such as an encoder of headend 106, is provided to a single client device such as TV 114. Should the output signal from a headend encoder 106 in one city like London fail, a similar signal from another headend unit in another city such as Edinburgh can be used from encoder 108. Upon switching of the signals from one headend device 106 to another device like 108, with the signals not synchronized there can be a video picture change either forward or backward in time. However, with markers inserted like MK1-MK3 into the ISD in accordance with embodiments of the present invention, the encoders can synchronize the original baseband signal so that the signals align when a switch occurs if one signal fails.

The method inserts markers that can take different forms. The markers go into the baseband signal of the SDI that are used by the encoders to latch the same timing information such as the PTS on identical frames across all compressed outputs generated by the different encoders. The markers can be proprietary or included as special marks arbitrarily created in non active parts of the baseband signal. Alternatively, the markers can be based on available timing standards for SDI such as vertical interval time code (VITC).

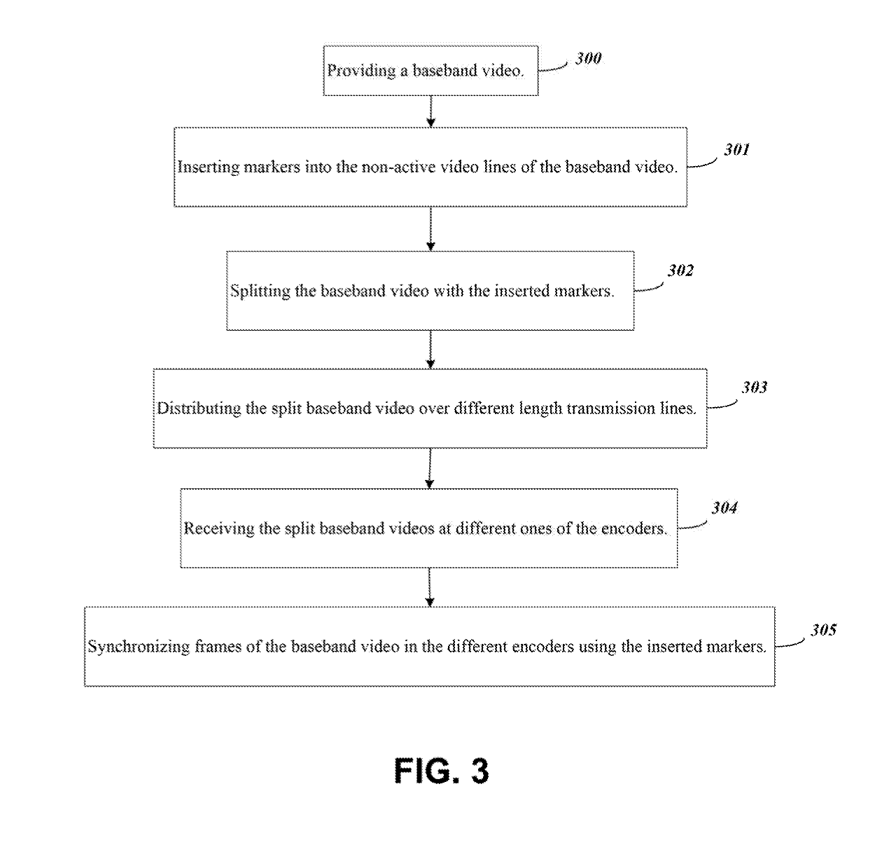

FIG. 3 is a flow chart illustrating a method of inserting markers in a baseband video in accordance with embodiments of the present invention. First in step 300 the original baseband video is obtained. In step 301, the markers are inserted into the non-active video lines of the baseband video. The SDI signal with the inserted markers can then be split in step 302 and distributed over different length transmission lines in step 303. The split baseband videos are then received at the different encoders in step 304. Finally, in step 305 the baseband video frames of the signals are synchronized in the different encoders using the inserted markers.

In one embodiment, the marker used can be the VITC. By just imposing a VITC stamping on the SDI, the system can use the VITC timecode as a Network Time Protocol (NTP) clock, which will allow distant encoders to make a correlation between a video frame and its corresponding clock time. Once VITC is inserted in the SDI source, the SDI can be split and distributed across different coax cables of different lengths for reaching different geographical regions. Other devices might be used to carry SDI over Fiber for longer reach.

The result of the transportation across different lengths will be arrival of the same video frame at different time to different encoders, but the VITC can be used to synchronize these time differences. Through the VITC timestamping, the encoder will be able to know the original time at which this frame was processed and will use this info to trigger synchronization of video chunking. A simple example on how to use the signal is to finish the current chunk and start with a new video chunk every time a new second comes around.

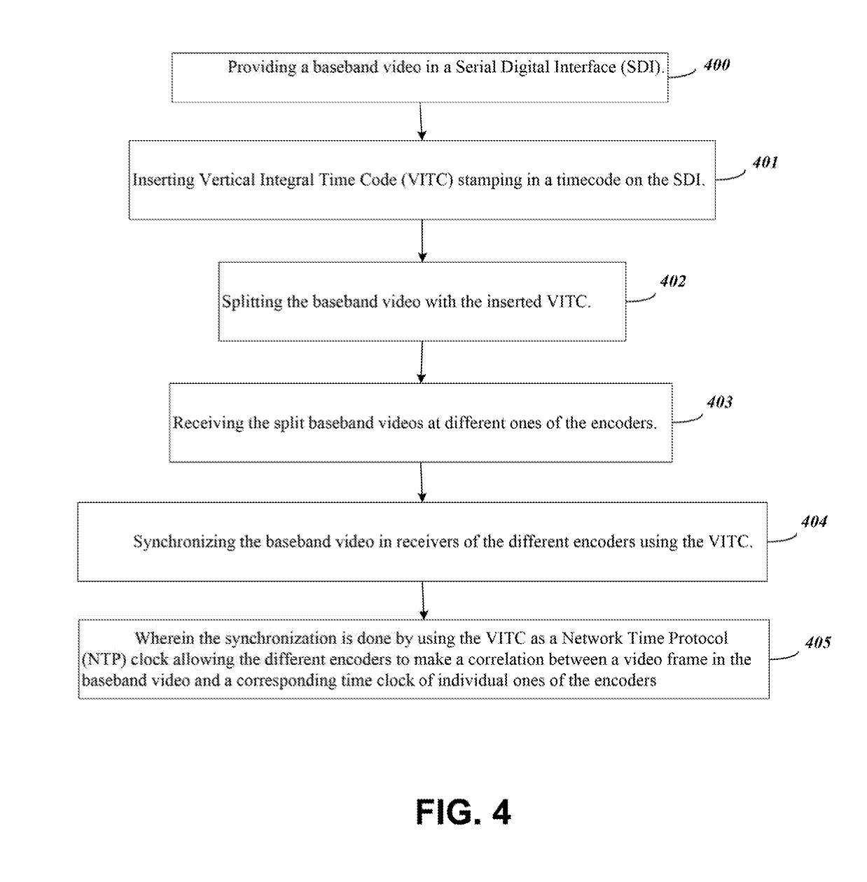

FIG. 4 is a flow chart showing a method of inserting VITC stamps as a marker in one embodiment of the present invention. In a first step 400, a baseband video signal is provided as an SDI signal. In step 401, the VITC stamping is provided as a timecode on the SDI. The SDI signal with the inserted VITC stamps can then be split in step 402 and provided to different ones of the encoders in step 403. The VITC can then be used in the different encoders to synchronize the baseband video signals with each other in step 404. As further indicated in step 405, the synchronization can be done by using the VITC as a Network Time Protocol (NTP) clock allowing the different encoders to make a correlation between a video frame in the baseband video and a corresponding time clock of individual ones of the encoders.

Although the present invention has been described above with particularity, this was merely to teach one of ordinary skill in the art how to make and use the invention. Many additional modifications will fall within the scope of the invention as that scope is defined by the following claims.

What is claimed:

1. The method for synchronizing Multiple Bit Rate (MBR) streams across multiple encoders comprising:
providing a baseband video;
inserting markers into the non-active video lines of the baseband video;
splitting the baseband video with the inserted markers;
distributing the split baseband video over different length transmission lines;
receiving the split baseband video at the encoders;
synchronizing frames of the baseband video in the different encoders using the inserted markers.

2. The method of claim 1,
wherein the inserting markers comprises providing Vertical Integral Time Code (VITC) stamping in a timecode on a Serial Digital Interface (SDI) carrying the baseband video.

3. The method of claim 2,
wherein the synchronization is done by using the VITC as a Network Time Protocol (NTP) clock allowing the encoders to make a correlation between a video frame in the baseband video and a corresponding time clock of individual ones of the encoders.

4. The method of claim 2,
wherein splitting the baseband video comprises splitting the baseband video signal on the SDI after the VITC is inserted.

5. The method for synchronizing Adaptive Bit Rate (ABR) streams across multiple encoders comprising:
providing a baseband video in a Serial Digital Interface (SDI);
inserting Vertical Integral Time Code (VITC) stamping in a timecode on the SDI;
splitting the baseband video with the inserted VITC;
receiving the split baseband videos at the encoders;
synchronizing the baseband video in receivers of the different encoders using the VITC.

6. The method of claim 5,
wherein the synchronization is done by using the VITC as a Network Time Protocol (NTP) clock allowing the encoders to make a correlation between a video frame in the baseband video and a corresponding time clock of individual ones of the encoders.

7. A system for synchronizing Multiple Bit Rate (MBR) streams across multiple encoders comprising:
an Integrated Receiver Decoder (IRD) including a processor and a memory connected to the processor, the memory storing code that when executed causes the processor to perform the steps of: providing a baseband video; and inserting markers into the non-active video lines of the baseband video;
a splitter for splitting the baseband video with the inserted markers and distributing the split baseband video over different length transmission lines; and
encoders for receiving the split baseband video and synchronizing frames of the baseband video using the inserted markers.

8. The system of claim 7,
wherein the inserting markers includes providing Vertical Integral Time Code (VITC) stamping in a timecode on an Serial Digital Interface (SDI) carrying the baseband video.

9. The system of claim 8,
wherein the synchronization is done by using the VITC as a Network Time Protocol (NTP) clock allowing the encoders to make a correlation between a video frame in the baseband video and a corresponding time clock of individual ones of the encoders.

10. The system of claim 8,
wherein splitting the baseband video comprises splitting the baseband video signal on the SDI after the VITC is inserted.
